(19) United States
(12) Patent Application Publication
(10) Pub. No.: US 2026/0264722 A1
(43) Pub. Date: Sep. 10, 2026

(54) SYSTEM

(71) Applicant: SOFTBANK GROUP CORP., Tokyo (JP)

(72) Inventor: Nagao SUZUKI, Tokyo (JP)

(73) Assignee: SOFTBANK GROUP CORP., Tokyo (JP)

(21) Appl. No.: 19/555,508

(22) Filed: Mar. 3, 2026

Related U.S. Application Data
(60) Provisional application No. 63/766,589, filed on Mar. 4, 2025.

(51) Int. Cl. B60W 60/00; B60W 10/04; B60W 10/18; B60W 30/18; B60W 50/00; G05B 13/04

(52) U.S. Cl. CPC B60W 60/0027; B60W 10/04; B60W 10/18; B60W 30/18163; B60W 50/0098; G05B 13/04; B60W 2050/0028; B60W 2050/0052; B60W 2420/403; B60W 2420/408; B60W 2520/10; B60W 2552/10; B60W 2552/15; B60W 2552/30; B60W 2554/4041; B60W 2554/4042; B60W 2555/20; B60W 2556/10; B60W 2556/35; B60W 2556/45; B60W 2710/18; B60W 2720/10; B60W 2754/30

(57) ABSTRACT

A system for quickly and accurately calculating damages in traffic accidents is disclosed. This system comprises a reference information storage unit, a processing unit, an input unit, and an output unit, and stores digitized materials on traffic accident damages calculation standards. The user provides detailed accident information via the input unit. Based on this, the processing unit uses machine learning algorithms to learn from past case data and predicts damages based on similar cases. It utilizes generative AI and employs prompt text to achieve highly accurate predictions. The calculation results are visually presented via the output unit, allowing users to review details for each item. This enables users to obtain a damage compensation estimate quickly without retaining a lawyer, thereby reducing time and costs.

### CROSS-REFERENCE TO RELATED APPLICATION

This application claims priority under 35 U.S.C. § 119 to U.S. Provisional Patent Application No. 63/766,589, filed on Mar. 4, 2025, the entire contents of which are incorporated herein by reference.

### BACKGROUND

### Technical Field

The present disclosure relates to a system.

### Related Art

Japanese Patent Application Publication Laid-Open (JP-A) No. 2022-180282 discloses a persona chatbot control method performed by at least one processor, comprising: a step of receiving a user utterance; a step of adding to the user utterance a prompt containing a description of the chatbot's persona and related instructions; a step of encoding the prompt; and a step of inputting the encoded prompt into a language model to generate a chatbot utterance in response to the user utterance.

### SUMMARY

System and methos for calculating damages in traffic accidents are disclosed. Conventionally, calculating damages for traffic accidents required the involvement of lawyers or experts possessing specialized legal knowledge, leading to problems of time and cost. Furthermore, calculating damages necessitated reference to standard reference books known as the "Red Book" and "Blue Book," and appropriately interpreting and applying these standards was difficult for the general public. Furthermore, making predictions considering past court precedents was not straightforward, sometimes leading to uncertainty in damage compensation calculations.

The AI technology is utilized to digitize these reference books. By employing natural language processing technology and machine learning algorithms to automatically calculate damage compensation amounts, it enables the rapid and accurate provision of results. This allows ordinary people to easily obtain estimates of damage compensation amounts without needing to hire a lawyer, thereby reducing time and costs. Furthermore, it is expected to contribute to insurance companies by improving accident processing efficiency and enhancing customer service.

As a means to solve the problem, a system for calculating compensation amounts in traffic accidents is provided. This system comprises: a standard information storage unit that stores standard information related to traffic accidents; an input unit for inputting detailed information about the traffic accident; a processing unit that analyzes the input detailed information based on the standard information stored in the standard information storage unit and performs processing to calculate the compensation amount; and an output unit for outputting the calculated compensation amount. The reference information storage unit stores digitized versions of materials known as the "Red Book" and "Blue Book," which are standards for calculating traffic accident damages. The processing unit uses natural language processing technology to extract information necessary for calculating damages from these materials. Furthermore, the processing unit uses machine learning algorithms to learn from past case data and predict compensation amounts based on similar traffic accident cases. This enables users to obtain a quick and accurate estimate of compensation amounts without needing to hire a lawyer.

### BRIEF DESCRIPTION OF DRAWINGS

FIG. 1 is a conceptual diagram showing an example configuration of the data processing system according to the first embodiment.

FIG. 2 is a conceptual diagram showing an example of the main functional components of the data processing device and smart device according to the first embodiment.

FIG. 3 is a conceptual diagram showing an example configuration of the data processing system according to the second embodiment.

FIG. 4 is a conceptual diagram showing an example of the main functions of the data processing device and smart glasses according to the second embodiment.

FIG. 5 is a conceptual diagram showing an example configuration of a data processing system according to a third embodiment.

FIG. 6 is a conceptual diagram showing an example of the main functions of the data processing device and headset-type terminal according to the third embodiment.

FIG. 7 is a conceptual diagram showing an example configuration of a data processing system according to the fourth embodiment.

FIG. 8 is a conceptual diagram showing an example of the main functions of the data processing device and robot according to the fourth embodiment.

FIG. 9 shows an emotion map onto which multiple emotions are mapped.

FIG. 10 shows an emotion map onto which multiple emotions are mapped.

### DETAILED DESCRIPTION

The following describes an example embodiment of a system according to the present disclosure with reference to the accompanying drawings.

First, the terminology used in the following description is explained.

In the following embodiments, a processor (hereinafter simply referred to as a "processor") may be a single arithmetic unit or a combination of multiple arithmetic units. Furthermore, the processor may be a single type of arithmetic unit or a combination of multiple types of arithmetic units. Examples of processing units include a CPU (Central Processing Unit), a GPU (Graphics Processing Unit), a GPGPU (General-Purpose Computing on Graphics Processing Units), an APU (Accelerated Processing Unit), and the like.

In the following embodiments, signed RAM (Random Access Memory) is a memory where information is temporarily stored and is used as working memory by the processor.

In the following embodiments, the signed storage is one or more non-volatile storage devices that store various programs and various parameters, etc. Examples of non-volatile storage devices include flash memory (SSD (Solid State Drive)), magnetic disks (e.g., hard disk), or magnetic tape.

In the following embodiments, the communication I/F (Interface) is an interface including a communication processor and an antenna, etc. The communication I/F governs communication between multiple computers. Examples of communication standards applicable to the communication I/F include 5G (5th Generation Mobile Communication System), Wi-Fi (registered trademark), or Bluetooth (registered trademark), among others.

In the following embodiments, "A and/or B" is synonymous with "at least one of A and B." That is, "A and/or B" may mean A alone, B alone, or a combination of A and B. Furthermore, in this specification, when three or more items are connected using "and/or," the same concept applies as for "A and/or B".

### First Embodiment

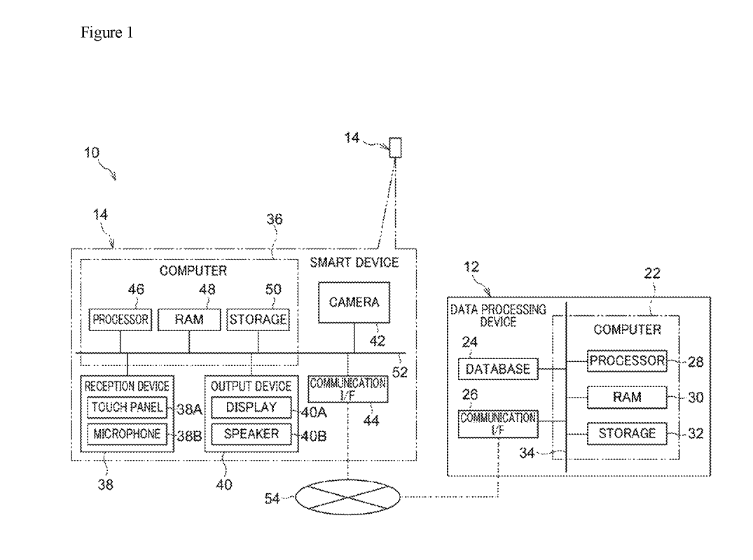

FIG. 1 shows an example configuration of a data processing system 10 according to the first embodiment.

As shown in FIG. 1, the data processing system 10 includes a data processing device 12 and a smart device 14. An example of the data processing device 12 is a server.

The data processing device 12 includes a computer 22, a database 24, and a communication I/F 26. The computer 22 is an example of a "computer" according to the technology of the present disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 include a WAN (Wide Area Network) and/or a LAN (Local Area Network).

The smart device 14 includes a computer 36, a reception device 38, an output device 40, a camera 42, and a communication I/F 44. The computer 36 includes a processor 46, RAM 48, and storage 50. The processor 46, RAM 48, and storage 50 are connected to a bus 52. The reception device 38, output device 40, and camera 42 are also connected to the bus 52. The reception device 38, output device 40, and camera 42 are also connected to the bus 52.

The reception device 38 includes a touch panel 38A and a microphone 38B, etc., and receives user input. The touch panel 38A receives user input via contact with an indicator (e.g., a pen or finger) by detecting such contact. The microphone 38B receives voice-based user input by detecting the user's voice. The control unit 46A transmits data indicating the user input received via the touch panel 38A and microphone 38B to the data processing unit 12. Within the data processing unit 12, the specific processing unit 290 acquires the data indicating the user input.

The output device 40 includes a display 40A and a speaker 40B, among others. It presents data to the user 20 by outputting it in a form perceptible to the user 20 (e.g., voice and/or text). The display 40A displays visual information such as text and images according to instructions from the processor 46. The speaker 40B outputs voice according to instructions from the processor 46. Camera 42 is a compact digital camera equipped with an optical system including a lens, aperture, and shutter, and an imaging element such as a CMOS (Complementary Metal-Oxide-Semiconductor) image sensor or a CCD (Charge Coupled Device) image sensor.

Communication I/F 44 is connected to network 54. Communication I/Fs 44 and 26 handle the exchange of various information between processor 46 and processor 28 via network 54.

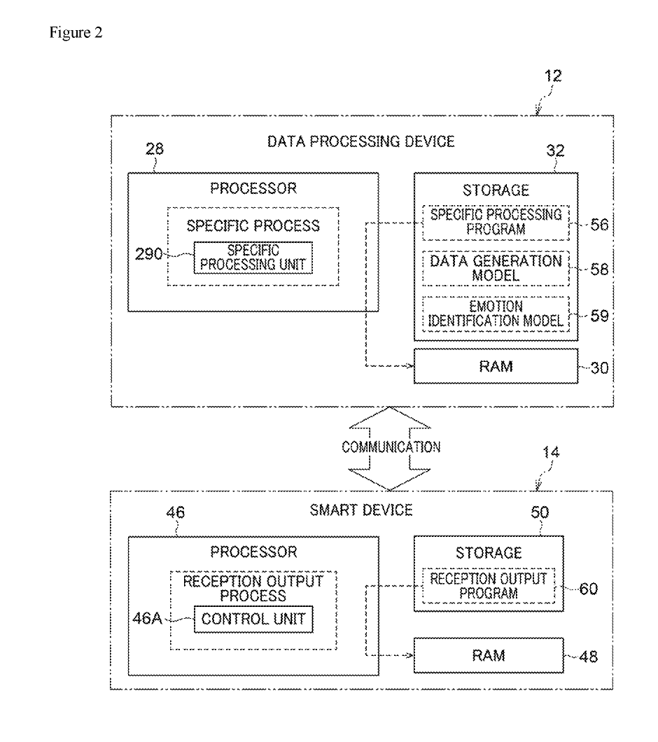

FIG. 2 shows an example of the main functions of the data processing device 12 and the smart device 14.

As shown in FIG. 2, specific processing is performed by processor 28 in data processing device 12. Specific processing program 56 is stored in storage 32. Specific processing program 56 is an example of a "program" related to the technology of this disclosure. Processor 28 reads specific processing program 56 from storage 32 and executes the read specific processing program 56 on RAM 30. Specific processing is realized by processor 28 operating as specific processing unit 290 according to specific processing program 56 executed on RAM 30. The specific processing is realized by the processor 28 operating as a specific processing unit 290 according to the specific processing program 56 executed on the RAM 30.

Storage 32 stores a data generation model 58 and an emotion identification model 59. The data generation model 58 and emotion identification model 59 are used by specific processing unit 290. Specific processing unit 290 can estimate a user's emotion using emotion identification model 59 and perform specific processing using the user's emotion. The emotion estimation function (emotion identification function) using the emotion identification model 59 performs various estimations and predictions concerning the user's emotion, including estimation and prediction of the user's emotion, but is not limited to such examples. Furthermore, estimation and prediction of emotion also includes, for example, analysis (parsing) of emotion.

The smart device 14 performs reception output processing via the processor 46. The reception output program 60 is stored in the storage 50. The reception output program 60 is used in conjunction with the specific processing program 56 by the data processing system 10. The processor 46 reads the reception output program 60 from the storage 50 and executes the read reception output program 60 on the RAM 48. The specific processing is performed by the processor 46 operating as a control unit 46A according to the specific processing program 60 executed on the RAM 48. Note that the smart device 14 may also have data generation models and emotion identification models similar to the data generation model 58 and emotion identification model 59, and may perform processing similar to that of the specific processing unit 290 using these models. The reception output processing is realized by the processor 46 operating as the control unit 46A according to the reception output program 60 executed on the RAM 48.

Other devices besides the data processing device 12 may also have the data generation model 58. For example, a server device (e.g., a generation server) may have the data generation model 58. In this case, the data processing device 12 communicates with the server device having the data generation model 58 to obtain processing results (such as prediction results) obtained using the data generation model 58. Furthermore, the data processing device 12 may be the server device itself, or it may be a terminal device owned by a user (e.g., a mobile phone, robot, home appliance, etc.). Next, an example of processing by the data processing system 10 according to the first embodiment will be described.

### Example 1

The flow of the specific processing in Example 1 is described below. The components of the system described below are implemented by the data processing device 12 and the smart device 14. The data processing device 12 is referred to as the "server," and the smart device 14 is referred to as the "terminal."

### Implementation Examples for Carrying Out the Invention

The embodiment for implementing the present invention will now be described in further detail.

The system of the present invention comprises two main components: a server and a terminal. The server stores reference information concerning traffic accidents and performs the core function of calculating compensation amounts. The terminal, on the other hand, provides an interface for the user to input information and receive results.

First, the server configuration is described in detail. The server includes a reference information storage unit where materials known as the "Red Book" and "Blue Book"—the traffic accident damage compensation calculation standards—are stored in digital form. These materials are saved as text data and analyzed using natural language processing technology. Specifically, the server performs text tokenization, part-of-speech tagging, and semantic analysis to extract information necessary for calculating damages. For example, the reference information storage unit contains detailed records of clauses, precedents, calculation formulas, adjustment factors, and other elements relevant to damage calculation.

Furthermore, the server includes a processing unit where the calculation of damages is performed. The processing unit uses machine learning algorithms to learn from past case law data and predict compensation amounts based on similar traffic accident cases. For example, the past case law database contains detailed information such as accident type (rear-end collision, side collision, head-on collision, etc.), victim age, occupation, injury severity (minor injury, serious injury, presence of permanent disability), treatment duration, and income data necessary for calculating lost earnings. A predictive model is constructed based on this data. The processing unit uses this data to calculate each individual damage category (medical expenses, lost earnings, pain and suffering compensation, etc.) and then determines the total compensation amount.

Next, the terminal configuration is described in detail. The terminal includes an input unit and an output unit. The input unit provides an interface for the user to input detailed information about the traffic accident. For example, the user can input the accident location (city name, road name), date and time (year, month, day, time), weather conditions (sunny, rainy, snowy), accident type (rear-end collision, side collision, head-on collision), victim information (age, gender, occupation, income), injury severity (minor injury, serious injury, presence of permanent disability), and treatment duration (number of hospitalization days, number of outpatient visit days).This information is transmitted from the terminal to the server and used for processing on the server side.

The output unit provides an interface to present the calculated compensation amount to the user. For example, the calculation results are displayed not only in text format but may also be presented visually using graphs and charts for easier comprehension. Specifically, each item of the compensation amount (medical expenses, lost earnings, compensation for pain and suffering, etc.) is displayed individually, and the total compensation amount is shown. Additionally, comparison results with past similar cases, as well as details of the standards and precedents used in the calculation, may also be displayed. This allows the user to intuitively grasp the calculation results and verify detailed information as needed.

Thus, the system of the present invention achieves rapid and accurate calculation of damages in traffic accidents by linking a server and terminals. The combination of advanced data processing on the server side and a user-friendly interface on the terminal side enables users to easily obtain an estimate of damages without retaining a lawyer. This reduces time and costs and is expected to contribute to more efficient accident processing and improved customer service for insurance companies.

### System Configuration

The system according to this embodiment comprises a reference information storage unit, a processing unit, an input unit, and an output unit. The reference information storage unit stores reference information related to traffic accidents. Specifically, digitized versions of materials such as the "Red Book" and "Blue Book," which are standards for calculating traffic accident damages, are stored. This unit records in detail the clauses, precedents, calculation formulas, adjustment factors, etc., necessary for calculating damages, and analyzes them using natural language processing technology. For example, the reference information storage unit includes standards for damages by accident type, standards for calculating lost earnings based on the victim's age and occupation, standards for compensation for pain and suffering based on the severity of injury, and adjustment factors based on past precedents.

The processing unit analyzes the detailed traffic accident information based on the information stored in the reference information storage unit and calculates the amount of damages. This unit learns past case data using machine learning algorithms and predicts compensation amounts based on similar traffic accident cases. Specifically, the processing unit calculates compensation amounts according to accident type (rear-end collision, side collision, head-on collision, etc.), calculates lost earnings based on the victim's age and occupation, determines compensation for pain and suffering according to injury severity (minor injury, serious injury, presence of permanent disability), and calculates medical expenses based on the treatment period. Furthermore, the processing unit achieves more accurate predictions by referencing a database of past precedents and comparing them with similar cases.

The input unit provides an interface for users to input detailed information about the traffic accident. Specifically, the input unit provides a form for inputting information such as the accident location (city name, road name), date and time (year, month, day, time), weather conditions (clear, rainy, snowy), accident type (rear-end collision, side collision, head-on collision), victim information (age, gender, occupation, income), injury severity (minor injury, serious injury, presence of permanent disability), and treatment duration (number of hospitalization days, number of outpatient visit days). For example, users can easily input accident details using selection options or input fields, reducing the effort required for input and enabling the provision of accurate information.

The output section provides an interface to present the calculated compensation amount to the user. Specifically, it displays the calculation results not only in text format but also visually using graphs and charts for easier comprehension. For example, each compensation item (medical expenses, lost earnings, pain and suffering compensation, etc.) is shown separately, alongside the total compensation amount. Furthermore, comparison results with past similar cases and details of the standards and precedents used in the calculation may also be displayed. This allows the user to intuitively grasp the calculation results and verify detailed information as needed.

Specific examples of prompt sentences to be fed into the generative AI required for implementing the present invention include: "Please input detailed information about the traffic accident. Include the type of accident, victim information, severity of injuries, treatment period, etc." or "The calculated compensation amount is displayed. Please review the details for each item." These prompt sentences function as guides for users when utilizing the system, supporting smooth operation.

### Implementation Steps

### Step 1: Storing Reference Information

This step involves storing reference information related to traffic accidents in the reference information storage unit. In this step, materials known as the "Red Book" and "Blue Book"—the traffic accident damage compensation calculation standards—are digitized and saved as text data. Specifically, it records in detail the clauses, precedents, calculation formulas, adjustment factors, etc., necessary for calculating the amount of damages. This information must be stored accurately and comprehensively because it will be analyzed using natural language processing technology in subsequent processing.

### Step 2: Inputting Traffic Accident Information

This step involves the user inputting detailed information about the traffic accident. Through the input section, the user enters the accident location, date and time, weather conditions, accident type, victim information, injury severity, treatment duration, and other details. For example, the user can easily input accident details using selection menus or input fields, reducing the input effort and enabling the provision of accurate information.

### Step 3: Information Analysis and Calculation of Compensation Amount

This step involves the processing unit analyzing the detailed accident information and calculating the compensation amount. Here, based on information stored in the reference information storage unit, machine learning algorithms are used to learn from past case data, enabling the prediction of compensation amounts based on similar accident cases. Specifically, it calculates compensation amounts according to the accident type, lost earnings based on the victim's age and occupation, compensation for pain and suffering according to the severity of injuries, and medical expenses based on the treatment period.

### Step 4: Building a Prediction Model Using Generative AI

This step involves constructing a prediction model using generative AI. Here, the system learns from past case data and predicts compensation amounts based on similar traffic accident cases. Examples of prompt sentences fed to the generative AI include: "Based on past traffic accident case data, predict the compensation amount for similar cases," or "Considering the accident type, victim information, and injury severity, calculate the optimal compensation amount." This enables the AI to utilize past data to make more accurate predictions.

### Step 5: Outputting the Calculation Results

This step presents the calculated compensation amount to the user. Through the output unit, the calculation result is displayed not only in text format but also presented visually using graphs and charts for easier comprehension. Specifically, each item of the compensation amount is displayed individually, and the total compensation amount is shown. Additionally, comparison results with past similar cases and details of the standards and precedents used in the calculation may also be displayed. This allows the user to intuitively grasp the calculation results and verify detailed information as needed.

### Specific Use Cases

For example, consider a victim involved in a traffic accident who needs to quickly calculate the amount of damages. This victim uses the system of the present invention to input the details of the accident. First, through the input section, they enter the city name and road name as the location of the accident, and specify the year, month, day, and time. Next, they select the weather from options like clear, rainy, or snowy, and choose the type of accident from options like rear-end collision, side collision, or head-on collision. Additionally, the victim inputs their information, including age, gender, occupation, and income, and specifies the severity of injuries as minor injury, serious injury, or presence of permanent disability. The treatment period is also entered, including the number of days hospitalized and the number of days receiving outpatient treatment.

Once this information is entered, the system calculates the compensation amount in the processing unit based on the traffic accident compensation calculation standards stored in the reference information storage unit. The processing unit uses machine learning algorithms to learn from past case data and make predictions based on similar traffic accident cases. For example, the past case database includes standards for compensation amounts by accident type, calculation standards for lost earnings based on the victim's age and occupation, standards for compensation for pain and suffering based on the severity of injuries, and formulas for calculating medical expenses based on the treatment period.

In the step using generative AI, prompts such as "Please predict the compensation amount for similar cases based on past traffic accident precedent data" or "Please calculate the optimal compensation amount considering the accident type, victim information, and injury severity" are used. This enables the AI to utilize past data to make more accurate predictions.

Finally, the calculated damages amount is presented to the user via the output section. The calculation results are displayed not only in text format but also presented visually using graphs and charts for easier comprehension. Specifically, each component of the damages amount (medical expenses, lost earnings, compensation for pain and suffering, etc.) is shown individually, alongside the total compensation amount. Additionally, comparison results with past similar cases, as well as details of the standards and precedents used in the calculation, may also be displayed. This allows users to intuitively grasp the calculation results and verify detailed information as needed.

### Application Example 1

The flow of specific processing in Application Example 1 is described below. The components of the system described below are implemented by the data processing device 12 and the smart device 14. The data processing device 12 is referred to as the "server," and the smart device 14 is referred to as the "terminal."

### Implementation Examples for the Present Invention

The embodiments for implementing the present invention will now be described in further detail. The present invention relates to an accident risk assessment system for autonomous vehicles, comprising a sensor input unit, a data analysis unit, a risk assessment unit, a driving strategy proposal unit, and a control feedback unit.

First, the sensor input unit collects data in real time from various sensors mounted on the autonomous vehicle. This unit uses sensors such as LIDAR, cameras, and radar to scan the vehicle's surrounding environment in detail. For example, the LIDAR uses laser light to measure the distance to surrounding objects with high precision and generate a three-dimensional environmental map. This enables the vehicle to accurately determine the position and shape of surrounding obstacles. Cameras acquire visual information and are used to recognize traffic light colors and road signs. For example, if a red light is detected, the vehicle is automatically controlled to stop. Radar can stably detect the position and speed of obstacles even in adverse weather conditions such as rain or fog, supporting the vehicle's safe operation.

Next, the data analysis unit processes data obtained from the sensor input unit to gain a detailed understanding of the current driving situation. This unit performs data filtering and noise reduction, and implements positional mapping. For example, it analyzes data in real time to accurately grasp the movement and position of surrounding vehicles, understanding the vehicle's dynamic environment. It also analyzes road shape, gradient, and the presence of curves to provide information for optimizing the vehicle's driving route. For instance, when encountering a sharp curve, the vehicle can automatically adjust its speed to safely navigate the curve.

The risk assessment unit evaluates the accident risk in the current situation based on information processed by the data analysis unit, referencing a historical traffic accident database. This unit uses machine learning algorithms to learn from past accident data and calculate the probability of accidents occurring in similar situations. For example, it quantifies the risk in the current situation based on accident rates under specific speeds or weather conditions. Furthermore, by considering road congestion and the behavior of other vehicles in the risk assessment, it achieves higher prediction accuracy. For example, when traffic volume is high, the vehicle is controlled to increase the following distance, thereby reducing the risk of an accident.

The Driving Strategy Proposal Unit uses generative AI to propose optimal driving strategies based on the accident risk calculated by the Risk Assessment Unit. This unit utilizes prompt sentences to instruct the AI. Specific prompts used include: "Propose the optimal speed and following distance considering the current traffic conditions and weather conditions," or "Present a driving strategy to reduce accident risk." Based on these instructions, the AI proposes specific driving maneuvers such as speed adjustments, lane changes, and maintaining following distance. For example, during rainy weather, it proposes reducing speed and increasing following distance to achieve safer driving.

Finally, the control feedback unit feeds the driving strategy proposed by the driving strategy proposal unit back to the autonomous vehicle's control system to execute actual driving operations. For example, it adjusts the accelerator and brakes based on the proposed speed and controls the steering to maintain following distance. This feedback enables the autonomous vehicle to achieve safe driving based on real-time risk assessment. For instance, if a vehicle ahead makes an emergency stop, the system immediately applies the brakes to avoid a collision.

Thus, the system of the present invention contributes to enhancing the safety of autonomous driving technology and preventing accidents before they occur, thereby playing a crucial role in ensuring the safety of passengers and the surrounding environment.

### System Configuration

The system according to this embodiment comprises a sensor input unit, a data analysis unit, a risk assessment unit, a driving strategy proposal unit, and a control feedback unit. The sensor input unit collects data in real time from various sensors mounted on the autonomous vehicle. This unit uses sensors such as LIDAR, cameras, and radar to scan the vehicle's surrounding environment in detail. For example, LIDAR uses laser light to measure the distance to surrounding objects with high precision and generates a three-dimensional environmental map. This enables the vehicle to accurately determine the position and shape of surrounding obstacles. Cameras acquire visual information and are used to recognize traffic signal colors and road signs. For instance, upon detecting a red light, the vehicle is automatically controlled to stop. Radar can reliably detect the position and speed of obstacles even in adverse weather conditions such as rain or fog, supporting the vehicle's safe operation.

The data analysis unit processes data obtained from the sensor input unit to gain a detailed understanding of the current driving situation. This unit performs data filtering and noise reduction, and implements positional mapping. For example, it analyzes data in real time to accurately grasp the movement and position of surrounding vehicles, understanding the vehicle's dynamic environment. It also analyzes road shape, gradient, and the presence of curves, providing information to optimize the vehicle's driving route. For instance, when encountering a sharp curve, the vehicle automatically adjusts its speed to safely navigate the curve.

The risk assessment unit evaluates the accident risk in the current situation based on information processed by the data analysis unit, referencing a historical traffic accident database. This unit uses machine learning algorithms to learn from past accident data and calculate the probability of accidents occurring in similar situations. For example, it quantifies the risk in the current situation based on accident rates under specific speeds or weather conditions. Furthermore, by considering road congestion and the behavior of other vehicles in the risk assessment, it achieves higher prediction accuracy. For example, when traffic volume is high, the vehicle is controlled to increase the following distance, thereby reducing the risk of an accident.

The Driving Strategy Proposal Unit uses generative AI to propose optimal driving strategies based on the accident risk calculated by the Risk Assessment Unit. This unit utilizes prompt sentences to instruct the AI. Specific prompt sentences used include: "Propose the optimal speed and following distance considering the current traffic conditions and weather conditions," or "Present a driving strategy to reduce accident risk." Based on these instructions, the AI proposes specific driving maneuvers such as speed adjustments, lane changes, and maintaining following distance. For example, during rainy weather, it proposes reducing speed and increasing following distance to achieve safe driving.

The control feedback unit feeds the driving strategy proposed by the driving strategy proposal unit back to the autonomous vehicle's control system to execute actual driving operations. For example, it adjusts the accelerator and brakes based on the proposed speed and controls the steering to maintain following distance. This feedback enables the autonomous vehicle to achieve safe driving based on real-time risk assessment. For example, if a vehicle ahead makes an emergency stop, the system immediately applies the brakes to avoid a collision. Thus, the system according to this embodiment contributes to enhancing the safety of autonomous driving technology, preventing accidents before they occur, and plays a crucial role in ensuring the safety of passengers and the surrounding environment.

### Implementation Steps

### Step 1: Collection of Sensor Input Data

The sensor input unit collects data in real time from various sensors mounted on the autonomous vehicle, such as LIDAR, cameras, and radar. LIDAR uses laser light to measure the distance to surrounding objects with high precision and generates a 3D environmental map. This enables the vehicle to accurately determine the position and shape of surrounding obstacles. Cameras acquire visual information and are used to recognize traffic signal colors and road signs. For example, upon detecting a red light, the vehicle is automatically controlled to stop. Radar can reliably detect the position and speed of obstacles even in adverse weather conditions such as rain or fog, supporting safe vehicle operation.

### Step 2: Data Analysis and Environmental Awareness

The data analysis unit processes data obtained from the sensor input unit to gain a detailed understanding of the current driving situation. This unit performs data filtering and noise reduction, and implements positional mapping. For example, it analyzes data in real time to accurately grasp the movement and position of surrounding vehicles, thereby understanding the vehicle's dynamic environment. It also analyzes road shape, gradient, and the presence of curves, providing information to optimize the vehicle's driving route. For instance, when encountering a sharp curve, the vehicle can automatically adjust its speed to safely navigate the curve.

### Step 3: Accident Risk Assessment

The risk assessment unit evaluates the accident risk in the current situation based on information processed by the data analysis unit, referencing a historical accident database. This unit uses machine learning algorithms to learn from past accident data and calculate the probability of accidents occurring in similar situations. For example, it quantifies the risk in the current situation based on accident rates under specific speeds or weather conditions. Furthermore, by considering road congestion and the behavior of other vehicles in the risk assessment, it achieves a more accurate prediction.

### Step 4: Driving Strategy Proposal

The Driving Strategy Proposal Unit uses generative AI to propose optimal driving strategies based on the accident risk calculated by the Risk Assessment Unit. This unit provides instructions to the AI using prompt sentences. Specific prompts used include: "Propose the optimal speed and following distance considering current traffic conditions and weather conditions," or "Present a driving strategy to reduce accident risk." Based on these instructions, the AI proposes specific driving maneuvers such as speed adjustments, lane changes, and maintaining following distance. For example, it may propose reducing speed and increasing following distance during rainy conditions to achieve safer driving.

### Step 5: Control Feedback and Execution

The control feedback unit feeds the driving strategy proposed by the driving strategy proposal unit back to the autonomous vehicle's control system to execute actual driving operations. For example, it adjusts the accelerator and brakes based on the proposed speed and controls the steering to maintain the following distance. This feedback enables the autonomous vehicle to achieve safe driving based on real-time risk assessment. For example, if a vehicle ahead makes an emergency stop, the system immediately applies the brakes to avoid a collision.

### Specific Use Cases

Consider a scenario where an autonomous vehicle approaches a complex urban intersection. This intersection involves multiple lanes crossing, with frequent traffic from signals, pedestrians, and other vehicles. The sensor input unit uses LIDAR to measure the distance to surrounding objects with high precision and generates a 3D environmental map. This enables the vehicle to accurately determine the positions of other vehicles and pedestrians within the intersection. The camera recognizes traffic light colors and provides information to stop the vehicle when the light is red. The radar reliably detects the position and speed of obstacles even in adverse weather conditions, supporting the vehicle's safe operation.

The data analysis unit processes data obtained from the sensor input unit in real time to understand the dynamic environment within the intersection. For example, it analyzes the movement and position of other vehicles to predict the vehicle's direction of travel. It also analyzes the road shape and traffic signal status, providing information to optimize the vehicle's driving route. If a sharp curve is encountered, the vehicle automatically adjusts its speed to safely navigate the curve.

The Risk Assessment Unit evaluates accident risk within the intersection based on information processed by the Data Analysis Unit, referencing a historical traffic accident database. Using machine learning algorithms, it learns from past accident data and calculates the probability of accidents occurring in similar situations. For example, it quantifies the risk in the current situation based on the accident rate at specific speeds or weather conditions within intersections. When traffic volume is high, the vehicle is controlled to increase the following distance, reducing the risk of accidents.

The Driving Strategy Proposal Unit proposes optimal driving strategies using generative AI based on the accident risk calculated by the Risk Assessment Unit. Prompt sentences used include: "Propose the optimal direction and speed considering the current intersection traffic conditions and signal status," or "Present a driving strategy to reduce accident risk within the intersection." Based on these instructions, the AI proposes specific driving operations such as direction selection, speed adjustment, and maintaining following distance.

The control feedback unit feeds the driving strategy proposed by the driving strategy proposal unit back to the autonomous vehicle's control system to execute actual driving operations. It adjusts the accelerator and brakes based on the proposed speed and controls the steering to maintain following distance. If a vehicle ahead makes an emergency stop, the system immediately applies the brakes to avoid a collision. Thus, the system of the present invention plays a crucial role in enabling autonomous vehicles to safely navigate complex urban intersections, ensuring the safety of passengers and surrounding areas.

The specific processing unit 290 transmits the result of the specific processing to the smart device 14. On the smart device 14, the control unit 46A causes the output device 40 to output the result of the specific processing. The microphone 38B acquires audio indicating user input regarding the result of the specific processing. The control unit 46A transmits the audio data indicating the user input acquired by the microphone 38B to the data processing unit 12. At the data processing unit 12, the specific processing unit 290 acquires the audio data.

The data generation model 58 is a so-called generative AI (Artificial Intelligence). An example of the data generation model 58 is ChatGPT (registered trademark) (Internet search <URL: https://openai.com/blog/chatgpt>). The data generation model 58 is obtained by performing deep learning on a neural network. The data generation model 58 receives input of a prompt containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs specific processing based on the output inference result. Here, inference refers to, for example, analysis, classification, prediction, and/or summarization. The specific processing unit 290 performs the specific processing described above using the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but is not limited to such examples. Furthermore, the AI may be an AI agent. Also, when the processing of the aforementioned components is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the smart device 14.

### Second Embodiment

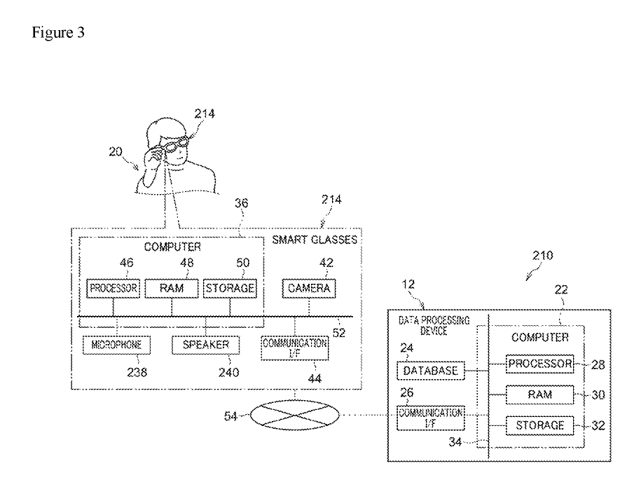

FIG. 3 shows an example configuration of the data processing system 210 according to the second embodiment.

As shown in FIG. 3, the data processing system 210 includes a data processing device 12 and smart glasses 214. An example of the data processing device 12 is a server.

The data processing device 12 includes a computer 22, a database 24, and a communication I/F 26. The computer 22 is an example of a "computer" related to the technology of the present disclosure. Computer 22 includes a processor 28, RAM 30, and storage 32. Processor 28, RAM 30, and storage 32 are connected to bus 34. Database 24 and communication I/F 26 are also connected to bus 34. Communication I/F 26 is connected to network 54. Examples of network 54 include a WAN (Wide Area Network) and/or a LAN (Local Area Network).

Smart glasses 214 include a computer 36, a microphone 238, a speaker 240, a camera 42, and a communication I/F 44. The computer 36 includes a processor 46, RAM 48, and storage 50. Processor 46, RAM 48, and storage 50 are connected to bus 52. Microphone 238, speaker 240, and camera 42 are also connected to bus 52.

Microphone 238 receives voice input from user 20 to accept instructions or other commands. Microphone 238 captures the voice input from user 20, converts the captured voice into audio data, and outputs it to processor 46. Speaker 240 outputs audio in accordance with instructions from processor 46.

The camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor. It captures images of the user's surroundings (e.g., within a field of view equivalent to that of a typical healthy individual).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

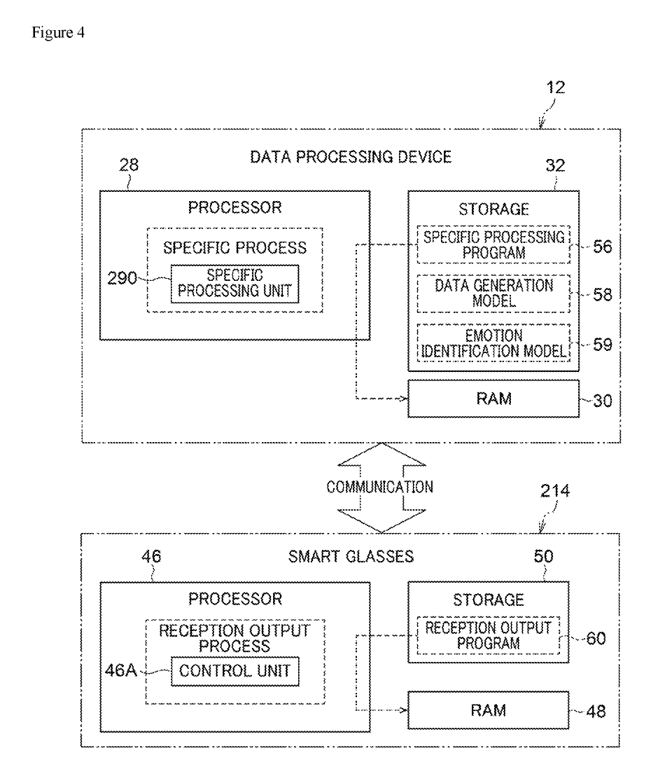

FIG. 4 shows an example of the main functions of the data processing device 12 and the smart glasses 214. As shown in FIG. 4, specific processing is performed by the processor 28 in the data processing device 12. The specific processing program 56 is stored in the storage 32.

The specific processing program 56 is an example of a "program" related to the technology of this disclosure. Processor 28 reads the specific processing program 56 from storage 32 and executes the read specific processing program 56 on RAM 30. The specific processing is realized by processor 28 operating as specific processing unit 290 according to the specific processing program 56 executed on RAM 30.

Storage 32 stores a data generation model 58 and an emotion identification model 59. The data generation model 58 and emotion identification model 59 are used by specific processing unit 290. Specific processing unit 290 can estimate a user's emotion using emotion identification model 59 and perform specific processing using the user's emotion. The emotion estimation function (emotion identification function) using the emotion identification model 59 performs various estimations and predictions concerning the user's emotion, including estimation and prediction of the user's emotion, but is not limited to such examples. Furthermore, estimation and prediction of emotion also includes, for example, analysis (parsing) of emotion.

In the smart glasses 214, the processor 46 performs the reception output processing. The reception output program 60 is stored in the storage 50. The processor 46 reads the reception output program 60 from the storage 50 and executes the read reception output program 60 on the RAM 48. The reception output processing is realized by the processor 46 operating as the control unit 46A according to the reception output program 60 executed on the RAM 48. The reception output processing is realized by the processor 46 operating as a control unit 46A according to the reception output program 60 executed on RAM 48. The smart glasses 214 may also have a data generation model 58 and an emotion identification model 59, and can perform processing similar to that of the identification processing unit 290 using these models.

Next, the identification processing performed by the identification processing unit 290 of the data processing device 12 is described. The components of the system described below are implemented by the data processing device 12 and the smart glasses 214. In the following description, the data processing device 12 is referred to as the "server," and the smart glasses 214 are referred to as the "terminal."

### Example 1

The flow of the specific processing in Example 1 described in the first embodiment is the same as described above, so the explanation is omitted.

### Application Example 1

The flow of the specific processing in Example 1 described in the first embodiment is the same as described above, so the explanation is omitted.

The specific processing unit 290 transmits the result of the specific processing to the smart glasses 214. In the smart glasses 214, the control unit 46A causes the speaker 240 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data.

Data Generation Model 58 is what is known as generative AI (Artificial Intelligence). An example of a data generation model 58 is ChatGPT (registered trademark) (Internet search <URL: https://openai.com/blog/chatgpt>). Data generation model 58 is obtained by performing deep learning on a neural network. Data generation model 58 receives input of a prompt containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58. The data generation model 58 includes AI other than generative AI. AI other than generative AI includes, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but is not limited to such examples. Furthermore, AI may be an AI agent. Additionally, when the processing of each of the above-mentioned parts is performed by AI, that processing may be performed in part or in whole by the AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the smart glasses 214.

### Third Embodiment

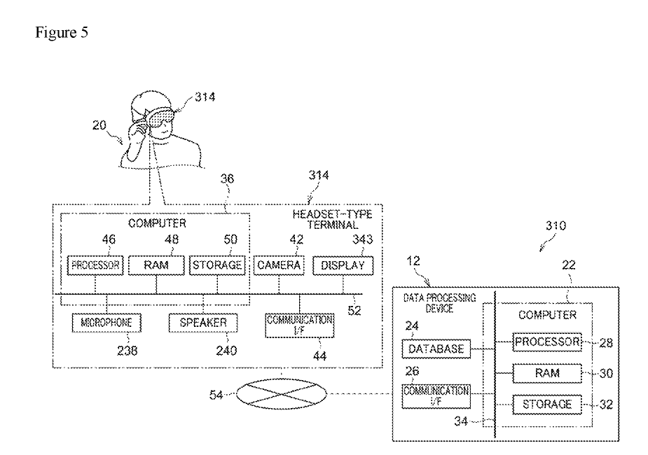

FIG. 5 shows an example configuration of the data processing system 310 according to the third embodiment.

As shown in FIG. 5, the data processing system 310 includes a data processing device 12 and a headset-type terminal 314. An example of the data processing device 12 is a server.

Data processing device 12 includes a computer 22, a database 24, and a communication I/F 26. Computer 22 is an example of a "computer" related to the technology of this disclosure. Computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 include a WAN (Wide Area Network) and/or a LAN (Local Area Network).

The headset-type terminal 314 comprises a computer 36, a microphone 238, a speaker 240, a camera 42, a communication I/F 44, and a display 343. The computer 36 includes a processor 46, RAM 48, and storage 50. The processor 46, RAM 48, and storage 50 are connected to the bus 52. Microphone 238, speaker 240, camera 42, and display 343 are also connected to bus 52.

Microphone 238 receives voice input from user 20 to accept instructions or other commands. Microphone 238 captures the voice input from user 20, converts the captured voice into audio data, and outputs it to processor 46. Speaker 240 outputs audio according to instructions from processor 46.

The camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor. It captures images of the user's surroundings (e.g., within a field of view equivalent to that of a typical healthy individual).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

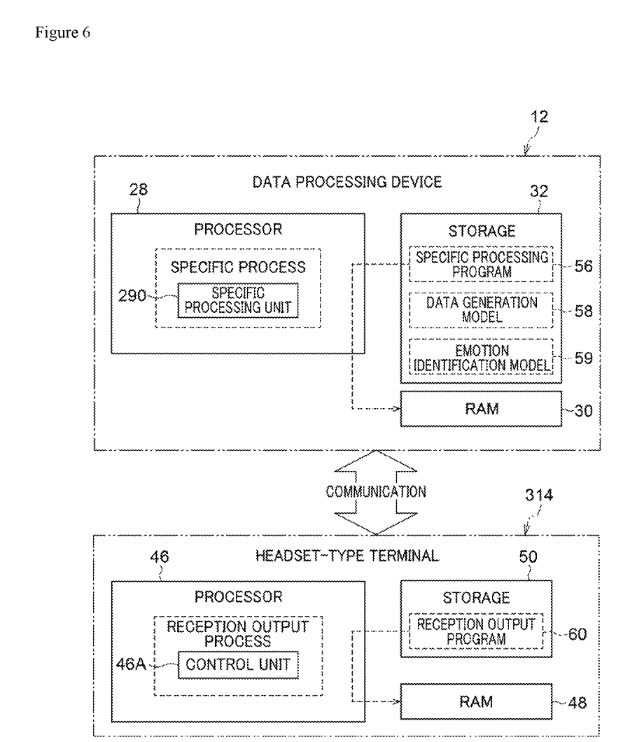

FIG. 6 shows an example of the main functions of the data processing device 12 and the headset-type terminal 314. As shown in FIG. 6, specific processing is performed by the processor 28 in the data processing device 12. The specific processing program 56 is stored in the storage 32.

The specific processing program 56 is an example of a "program" related to the technology of this disclosure. The processor 28 reads the specific processing program 56 from the storage 32 and executes the read specific processing program 56 on the RAM 30. The specific processing is realized by the processor 28 operating as a specific processing unit 290 according to the specific processing program 56 executed on the RAM 30.

Storage 32 stores a data generation model 58 and an emotion identification model 59. The data generation model 58 and the emotion identification model 59 are used by specific processing unit 290.

In the headset-type terminal 314, reception output processing is performed by the processor 46. The reception output program 60 is stored in the storage 50. Processor 46 reads the reception output program 60 from storage 50 and executes the read reception output program 60 on RAM 48. Reception output processing is achieved by processor 46 operating as control unit 46A according to the reception output program 60 executed on RAM 48.

Next, the specific processing performed by the specific processing unit 290 of the data processing device 12 is described. The various parts of the system described below are implemented by the data processing device 12 and the headset-type terminal 314. In the following description, the data processing device 12 is referred to as the "server," and the headset-type terminal 314 is referred to as the "terminal."

### Example 1

The flow of the specific processing is the same as that described in Example 1 of the first embodiment, so the description is omitted.

### Application Example 1

The flow of the specific processing in Example 1 described in the first embodiment is the same as above, so the explanation is omitted.

The specific processing unit 290 transmits the result of the specific processing to the headset-type terminal 314. At the headset-type terminal 314, the control unit 46A causes the speaker 240 and the display 343 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data.

Data Generation Model 58 is what is known as generative AI (Artificial Intelligence). An example of a data generation model 58 is ChatGPT (registered trademark) (Internet search <URL: https://openai.com/blog/chatgpt>). Data generation model 58 is obtained by performing deep learning on a neural network. Data generation model 58 receives input of a prompt containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58. The data generation model 58 includes AI other than generative AI. AI other than generative AI includes, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but is not limited to such examples. Furthermore, the AI may be an AI agent. Also, when the processing of the aforementioned components is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using the generated AI. For example, the provision unit is implemented by the output device 40 of the smart device 14 or the specific processing unit 290 of the data processing device 12 and provides the generated cooking menu. The generation unit is implemented by the specific processing unit 290 of the data processing device 12 and generates a cooking menu using generative AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12. However, the technology disclosed herein is not limited to this, and specific processing may also be performed by the headset-type terminal 314.

### Fourth Embodiment

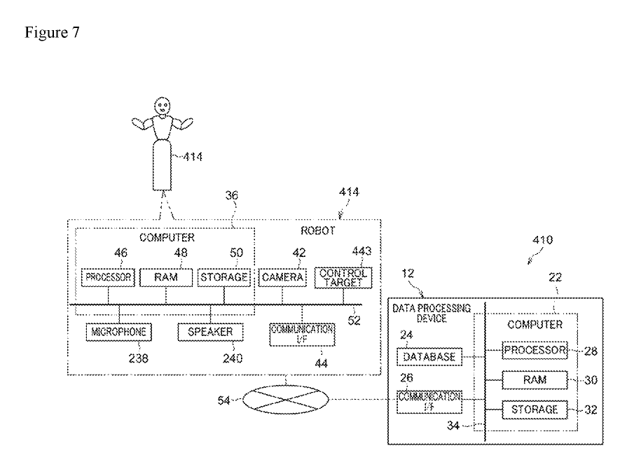

FIG. 7 shows an example configuration of the data processing system 410 according to the fourth embodiment.

As shown in FIG. 7, the data processing system 410 includes a data processing device 12 and a robot 414. An example of the data processing device 12 is a server.

The data processing device 12 includes a computer 22, a database 24, and a communication I/F 26. The computer 22 is an example of a "computer" related to the technology of this disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 is WAN (Wide Area Network) and/or LAN (Local Area Network) are examples.

Robot 414 includes a computer 36, a microphone 238, a speaker 240, a camera 42, a communication I/F 44, and a control target 443. Computer 36 includes a processor 46, RAM 48, and storage 50. Processor 46, RAM 48, and storage 50 are connected to bus 52. Furthermore, microphone 238, speaker 240, camera 42, and controlled object 443 are also connected to bus 52.

Microphone 238 receives voice commands from user 20 by capturing the user's spoken audio. Microphone 238 captures the audio emitted by user 20, converts the captured audio into audio data, and outputs it to processor 46. Speaker 240 outputs audio according to instructions from processor 46.

The camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor. It captures images of the user's surroundings (e.g., an imaging range defined by a field of view equivalent to that of a typical healthy person).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

The control target 443 includes a display device, LEDs for the eye section, and motors for driving the arms, hands, legs, etc. The posture and gestures of robot 414 are controlled by controlling the motors for the arms, hands, legs, etc. Part of the robot 414's emotions can be expressed by controlling these motors. Furthermore, the robot 414's facial expressions can also be expressed by controlling the light emission state of the LEDs in its eyes.

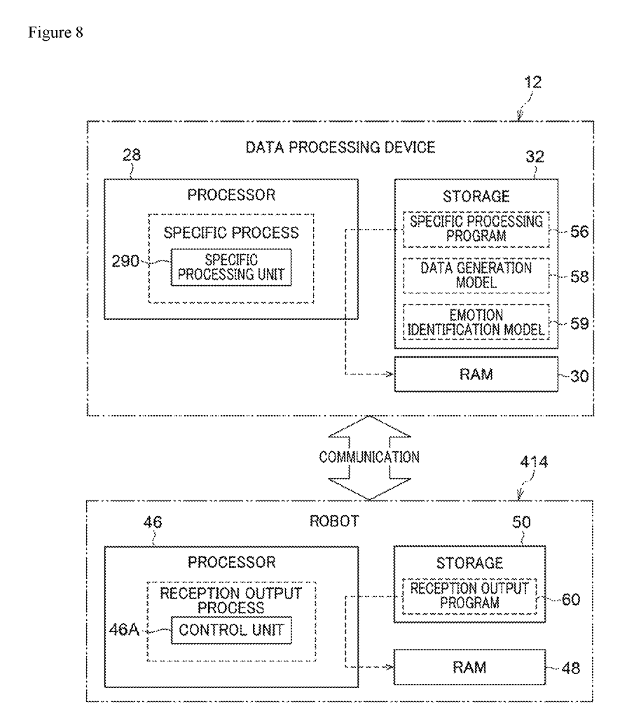

FIG. 8 shows an example of the main functions of the data processing device 12 and the robot 414. As shown in FIG. 8, specific processing is performed by the processor 28 in the data processing device 12. The specific processing program 56 is stored in the storage 32.

The specific processing program 56 is an example of a "program" pertaining to the technology of this disclosure. The processor 28 reads the specific processing program 56 from the storage 32 and executes the read specific processing program 56 on the RAM 30. The specific processing is realized by the processor 28 operating as a specific processing unit 290 according to the specific processing program 56 executed on the RAM 30.

Storage 32 stores a data generation model 58 and an emotion identification model 59. The data generation model 58 and the emotion identification model 59 are used by specific processing unit 290.

In robot 414, reception output processing is performed by processor 46. Storage 50 stores a reception output program 60. Processor 46 reads the reception output program 60 from storage 50 and executes the read reception output program 60 on RAM 48. Reception output processing is realized by the processor 46 operating as a control unit 46A according to the reception output program 60 executed on RAM 48.

Next, the specific processing performed by the specific processing unit 290 of the data processing device 12 is described. The various parts of the system described below are realized by the data processing device 12 and the robot 414. In the following description, the data processing device 12 is referred to as the "server," and the robot 414 is referred to as the "terminal."

### Example 1

The flow of the specific processing is the same as that described in Example 1 of the first embodiment, so the description is omitted.

### Application Example 1

The flow of the specific processing in Example 1 described in the above first embodiment is the same, so the explanation is omitted.

The specific processing unit 290 transmits the result of the specific processing to the robot 414. In the robot 414, the control unit 46A causes the speaker 240 and the control target 443 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data.

Data Generation Model 58 is a so-called generative AI (Artificial Intelligence). An example of a data generation model 58 is ChatGPT (registered trademark) (Internet search <URL: https://openai.com/blog/chatgpt>). Data Generation Model 58 is obtained by performing deep learning on a neural network. Data Generation Model 58 receives input of a prompt containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while using the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but is not limited to such examples. Furthermore, the AI may be an AI agent. Also, when the processing of the aforementioned parts is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the robot 414.

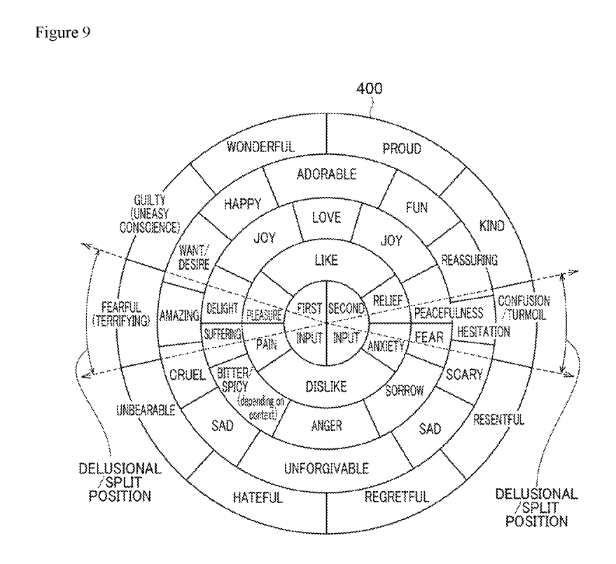

The emotion identification model 59, functioning as an emotion engine, may determine the user's emotion according to a specific mapping. Specifically, the emotion identification model 59 may determine the user's emotion according to an emotion map (see FIG. 9), which is a specific mapping. Furthermore, the emotion identification model 59 may similarly determine the robot's emotion, and the specific processing unit 290 may perform specific processing using the robot's emotion.

FIG. 9 is a diagram showing an emotion map 400 where multiple emotions are mapped. In the emotion map 400, emotions are arranged radially in concentric circles from the center. Emotions closer to the center of the concentric circles represent more primitive states. Emotions representing states or behaviors arising from mental states are placed further out in the concentric circles. Emotion is a concept encompassing affect and mental states. Generally, emotions generated from reactions occurring within the brain are placed on the left side of the concentric circles. Generally, emotions induced by situational judgment are placed on the right side of the concentric circles. Generally, emotions generated from reactions occurring within the brain and also induced by situational judgment are placed in the upper and lower directions of the concentric circles. Furthermore, the upper part of the concentric circle contains "pleasant" emotions, while the lower part contains "unpleasant" emotions. Thus, the Emotion Map 400 maps multiple emotions based on the structure of their origin, with emotions that tend to occur simultaneously mapped close together.

These emotions are distributed around the 3 o'clock position on Emotion Map 400, typically oscillating between feelings of security and anxiety. In the right half of Emotion Map 400, situational awareness takes precedence over internal sensations, resulting in a calmer impression.

The inner part of the emotion map 400 represents the mind, while the outer part represents actions. Therefore, the further out on the emotion map 400, the more visible the emotion becomes (manifesting in actions).

Here, human emotions are based on various balances, such as posture and blood sugar levels. When these balances deviate from the ideal, it indicates a state of discomfort; when they approach the ideal, it indicates a state of comfort. Similarly, for robots, automobiles, motorcycles, etc., emotions can be created based on various balances, such as posture and battery level. When these balances deviate from the ideal, it indicates a state of discomfort; when they approach the ideal, it indicates a state of comfort. Emotion maps, for example, Dr. Mitsuyoshi's Emotion Map (Research on Speech Emotion Recognition and Neurophysiological Signal Analysis of Emotions, Tokushima University, Doctoral Dissertation: https://ci.nii.ac.jp/naid/500000375379). The left half of the emotion map displays emotions belonging to the "Reaction" area, where sensory input dominates. The right half of the emotion map displays emotions belonging to the "Situation" domain, where situational awareness is dominant.

The emotion map defines two emotions that promote learning. One is the negative emotion around the center of the "repentance" or "reflection" area on the situation side. That is, when the robot experiences negative emotions like "I never want to feel this way again" or "I don't want to be scolded anymore. “The other is the positive emotion around "desire" on the reaction side. That is, when the robot feels positive emotions like "I want more" or "I want to know more."

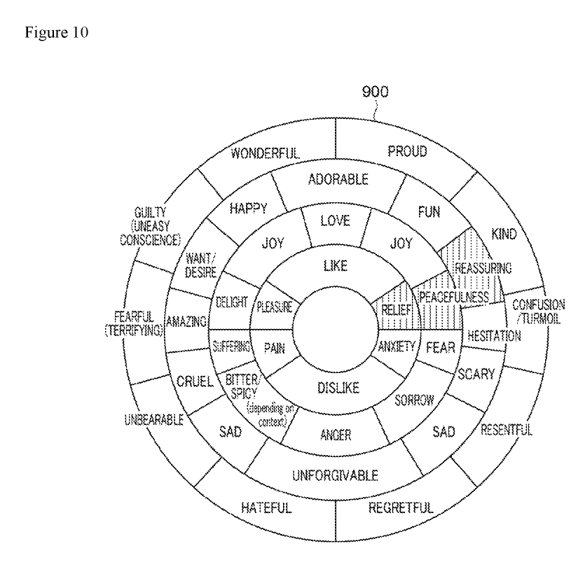

The emotion identification model 59 inputs user input into a pre-trained neural network, obtains emotion values representing each emotion shown in the emotion map 400, and determines the user's emotion. This neural network is pre-trained based on multiple training data sets, which are combinations of user input and emotion values representing each emotion shown in the emotion map 400. Furthermore, this neural network is trained such that emotions positioned close to each other, as shown in the emotion map 900 in FIG. 10, have similar values. FIG. 10 illustrates an example where multiple emotions, "reassurance," "tranquility," and "encouragement," have similar emotion values.

The system of the present disclosure has been described primarily in terms of the functions of the data processing device 12. However, the system of the present disclosure is not necessarily implemented on a server. The system of the present disclosure may be implemented as a general information processing system. For example, the present disclosure may be implemented as a software program operating on a personal computer or as an application operating on a smartphone or the like. The method of the present disclosure may also be provided to users in a Software as a Service (SaaS) format.

The above embodiment illustrated an example configuration where specific processing is performed by a single computer 22. However, the technology of the present disclosure is not limited to this. Distributed processing may be performed for specific processing by multiple computers, including computer 22. For example, the data generation model 58 may be provided in an external device of the data processing device 12, and data generation corresponding to input data may be performed in said external device.

The above embodiment described a configuration where a specific processing program 56 is stored in storage 32, but the technology disclosed herein is not limited to this. For example, the specific processing program 56 may be stored on a portable, computer-readable non-volatile storage medium such as a USB (Universal Serial Bus) memory. The specific processing program 56 stored on the non-volatile storage medium is installed on the computer 22 of the data processing device 12. The processor 28 executes specific processing according to the specific processing program 56.

Alternatively, the specific processing program 56 may be stored on a storage device, such as a server, connected to the data processing device 12 via the network 54. Upon request from the data processing device 12, the specific processing program 56 is downloaded and installed on the computer 22.

It should be noted that it is not necessary to store the entire specific processing program 56 on a storage device such as a server connected to the data processing device 12 via the network 54, or to store the entire specific processing program 56 in the storage 32. It is also possible to store only a portion of the specific processing program 56.

Various types of processors can be used as hardware resources to execute the specific processing. Examples of processors include a CPU, which is a general-purpose processor that functions as a hardware resource for executing specific processing by executing software, i.e., a program. Additionally, processors may include dedicated electronic circuits, such as FPGAs (Field-Programmable Gate Array), PLDs (Programmable Logic Device), or ASICs (Application Specific Integrated Circuit), which are processors with circuit configurations specifically designed to execute particular processing tasks. Each processor incorporates or connects to memory, and each processor executes specific processing by utilizing this memory.

The hardware resources for executing specific processing may be comprised of one of these various processors, or may be comprised of a combination of two or more processors of the same or different types (e.g., a combination of multiple FPGAs, or a combination of a CPU and an FPGA). Furthermore, the hardware resources for executing specific processing may be comprised of a single processor.

Examples of configurations using a single processor include: First, a configuration where one processor is formed by combining one or more CPUs with software, with this processor functioning as the hardware resource executing the specific processing. Second, there is a form using a processor that implements the entire system's functionality, including multiple hardware resources executing specific processing, on a single IC chip, as exemplified by a System-on-a-chip (SoC). Thus, specific processing is implemented as a hardware resource using one or more of the various processors described above.

Furthermore, regarding the hardware structure of these various processors, more specifically, electrical circuits combining circuit elements such as semiconductor devices can be used. Also, the specific processing described above is merely one example. Therefore, it goes without saying that within the scope not deviating from the main purpose, unnecessary steps may be omitted, new steps may be added, or the processing order may be changed.

The above description and illustrations provide a detailed explanation of the aspects pertaining to the technology of this disclosure and represent merely one example of the technology disclosed herein. For example, the above descriptions of the configuration, functions, actions, and effects are merely examples of the configuration, functions, actions, and effects of the part pertaining to the technology of this disclosure. Therefore, it goes without saying that within the scope not deviating from the main purpose of the technology of this disclosure, unnecessary parts may be omitted, new elements may be added, or replacements may be made to the above-described content and illustrated content. Furthermore, to avoid complexity and facilitate understanding of the technical aspects of the present disclosure, descriptions of common technical knowledge and the like that are not particularly necessary for enabling the present disclosure to have been omitted from the above descriptions and illustrations.

All references, patent applications, and technical specifications cited herein are incorporated by reference to the same extent as if each reference, patent application, and technical specification were specifically and individually cited herein.

The following further discloses the above embodiments.

### Supplementary Note 1

An accident risk assessment system for an autonomous vehicle comprising a sensor input unit, a data analysis unit, a risk assessment unit, a driving strategy proposal unit, and a control feedback unit, wherein the sensor input unit collects data in real time from various sensors mounted on the autonomous vehicle, acquiring information including the vehicle's speed, acceleration, position information, surrounding traffic conditions, weather conditions, and road conditions. The data analysis unit processes the data obtained from the sensor input unit, performing data filtering, noise removal, and location mapping to gain a detailed understanding of the current driving situation. The risk assessment unit evaluates the accident risk in the current situation based on the information processed by the data analysis unit, referencing a historical traffic accident database. It uses machine learning algorithms to learn from past accident data and calculates the probability of an accident occurring in similar situations. The Driving Strategy Proposal Unit proposes an optimal driving strategy using generative AI based on the accident risk calculated by the Risk Assessment Unit, and issues instructions to the AI using prompt text. The Control Feedback Unit feeds the proposed driving strategy from the Driving Strategy Proposal Unit back to the autonomous vehicle's control system to execute actual driving operations.

The sensor input unit uses sensors such as LIDAR, cameras, and radar to scan the vehicle's surrounding environment in detail, acquiring in real time the positions and movements of obstacles, the shape of the road, the status of traffic signals, and other information as described in Supplementary Note 1. This enables the vehicle to accurately grasp the surrounding situation and provides the foundational data for making appropriate driving decisions.

The driving strategy proposal unit employs generative AI, using prompts such as "Propose the optimal speed and following distance considering the current traffic conditions and weather conditions" or "Present a driving strategy to reduce accident risk." Based on these instructions, the AI proposes specific driving operations such as speed adjustment, lane changes, and maintaining following distance. This enables the autonomous vehicle to achieve safe driving based on real-time risk assessment.

### EXPLANATION OF SYMBOLS

10, 210, 310, 41 Data Processing System

12 Data Processing Device

14 Smart Device

214 Smart Glasses

314 Headset-Type Devices

414 Robot

What is claimed is:

1. An accident risk assessment and adaptive control system for an autonomous vehicle, comprising:
a sensor input subsystem comprising:
a LIDAR sensor configured to generate a three-dimensional point cloud representing surrounding objects,
a radar sensor configured to generate relative velocity vectors for detected objects, and
a camera configured to detect traffic signal states and lane markings;
a data analysis subsystem comprising at least one processor configured to:
fuse the point cloud and relative velocity vectors to generate a unified environmental state model comprising object position vectors and object velocity vectors; and
generate a baseline collision probability value;
a risk assessment subsystem configured to:
retrieve historical accident frequency data; and
compute a calibrated collision risk score based on the baseline collision probability value and the historical accident frequency data;
a driving strategy proposal unit comprising a generative neural network configured to:
receive environmental state information and the calibrated collision risk score; and
generate one or more candidate driving maneuvers; and
a control feedback subsystem configured to:
select a candidate driving maneuver; and
control vehicle actuators including throttle and braking systems according to the selected driving maneuver.

2. The system of claim 1, wherein the data analysis subsystem performs data filtering and noise reduction on sensor data.

3. The system of claim 1, wherein the unified environmental state model includes road curvature and road gradient information.

4. The system of claim 1, wherein the historical accident frequency data is indexed by at least vehicle speed and weather condition.

5. The system of claim 1, wherein the candidate driving maneuvers include at least one of speed adjustment, following-distance adjustment, or lane-change maneuver.

6. The system of claim 1, wherein the control feedback subsystem updates actuator control based on newly received sensor data.

7. A computer-implemented method for risk-aware control of an autonomous vehicle, comprising:
collecting multi-modal sensor data including LIDAR data, radar data, and camera data;
performing data filtering and positional mapping to determine positions of surrounding objects;
retrieving historical accident data corresponding to current environmental conditions;
computing a collision risk value based on the retrieved historical accident data and the sensor data;
inputting the collision risk value into a generative neural network;
generating one or more candidate driving maneuvers; and
controlling vehicle actuators according to a selected driving maneuver.

8. The method of claim 7, wherein performing positional mapping includes determining road curvature.

9. The method of claim 7, wherein computing the collision risk value includes using machine learning trained on past accident data.

10. The method of claim 7, wherein generating candidate driving maneuvers includes generating a speed adjustment proposal.

11. The method of claim 7, wherein generating candidate driving maneuvers includes generating a following-distance adjustment proposal.

12. The method of claim 7, further comprising updating the collision risk value based on newly acquired sensor data.

13. A non-transitory computer-readable storage medium storing instructions that, when executed by at least one processor of an autonomous vehicle, cause the processor to:
receive sensor data from LIDAR, radar, and camera subsystems;
generate environmental state information representing surrounding objects;
retrieve historical accident data;
compute a collision risk value;
generate one or more driving maneuver proposals using a generative neural network; and
control vehicle actuators based on a selected driving maneuver.

14. The storage medium of claim 13, wherein the environmental state information includes road geometry information.

15. The storage medium of claim 13, wherein the collision risk value is computed using historical accident frequency data associated with weather conditions.

16. The storage medium of claim 13, wherein the generative neural network generates a plurality of maneuver proposals.

17. The storage medium of claim 13, wherein the selected driving maneuver is determined based on reduction of collision risk.

18. The storage medium of claim 13, wherein the instructions further cause updating of actuator control in response to new sensor data.
